(19) United States
(12) Patent Application Publication
(10) Pub. No.: US 2015/0210040 A1
(43) Pub. Date: Jul. 30, 2015

(54) Cover for a motor vehicle roof

(71) Applicant: Webasto SE, Stockdorf (DE)

(72) Inventors: Hubert Böhm, Greifenberg (DE); Steffen Lorenz, Landsberg / Lech (DE); Johannes Thannheimer, Munchen (DE)

(21) Appl. No.: 14/597,712

(22) Filed: Jan. 15, 2015

(30) Foreign Application Priority Data
Jan. 24, 2014 (DE) 102014100838.3

(51) Int. Cl. B32B 7/02; B60Q 3/00; B60J 7/00; B32B 27/08; B32B 7/12; B60Q 3/02; B32B 17/06

(52) U.S. Cl. CPC B32B 7/02; B60Q 3/0213; B60Q 3/002; B32B 17/064; B32B 27/08; B32B 7/12; B60J 7/00; B32B 2264/105; B32B 2264/108; B32B 2307/418; B32B 2605/08

(57) ABSTRACT

A cover for a motor vehicle roof comprises a layer stack having a first sheet of planar extent having a main surface, a second sheet of planar extent having a main surface, an adhesive arranged between the main surfaces and serving for fixing the second sheet to the first sheet, wherein the refractive index of the second sheet has a first value and the refractive index of the adhesive has a second value such that a difference between the first value and the second value is greater than zero, in particular greater than or equal to 0.01.

The invention relates to a cover for a motor vehicle roof, in particular a cover which is arranged moveably relative to the vehicle roof, or a fixed glass element.

Motor vehicles can be equipped with a roof opening that is closed by a transparent cover. Light can pass into the interior of the vehicle through the transparent cover. The cover can be fitted in a fixed or moveable fashion in order to make it possible to free the roof opening at least in part.

It is desirable to specify a cover for a motor vehicle roof which can be used reliably as an optical wave guide.

In accordance with embodiments of the invention, a cover for a motor vehicle roof comprises a layer stack. The layer stack comprises a first sheet of planar extent having a main surface. The layer stack furthermore comprises a second sheet of planar extent having a main surface. The layer stack comprises an adhesive arranged between the main surfaces and serving for fixing the second sheet to the first sheet. The refractive index of the second sheet has a first value and the refractive index of the adhesive has a second value. A difference between the first value and the second value is greater than 0. In particular, the difference between the first value and the second value is at least 0.01.

The first sheet is a glass sheet, for example. The first sheet is a plastic sheet, for example. The second sheet is a glass sheet, for example. The second sheet is a plastic sheet, for example. In accordance with further embodiments, the first sheet and/or second sheet in each case comprises other materials suitable for a cover for a roof of a motor vehicle.

By virtue of the use of a sheet having a refractive index that deviates from the value of the refractive index of the adhesive, the plastic sheet can be used reliably as an optical wave guide. As a result of the jump in refractive index at the main surface between the second sheet and the adhesive, light propagating in the second sheet along a main propagation surface undergoes total internal reflection at the main surface. At a further main surface of the second sheet, which faces away from the adhesive, there is a transition from the second sheet to air. A sufficiently large jump in refractive index is provided here, too. Total internal reflection takes place at both main surfaces. Consequently, the cover can be used reliably as an optical wave guide. In particular, coupled-in light is distributed homogeneously over the entire area or virtually the entire area of the cover.

It is possible to use a tinted first sheet. The energy input, in particular as a result of insolation of sunlight into the motor vehicle is reduced as a result. It is possible to use a tinted cover which at the same time has sufficiently good light guiding properties.

In accordance with embodiments, a light source is arranged laterally with respect to the second sheet in order to couple light into a side of the second sheet which is transverse with respect to the main surface. The light source comprises, in particular, one or a plurality of light-emitting diodes (LED). In accordance with further embodiments, the light source comprises a light guiding element in order to couple light into the side of the second sheet.

In accordance with embodiments, the light source is arranged at a region of the first sheet which projects beyond the second sheet. Light that is radiated into the second sheet from the light source during operating is distributed in the second sheet over the entire area of the second sheet, since total internal reflection occurs at the two main surfaces of the second sheet. As a result of the light source being arranged at the first sheet, in the case of a moveable cover the light source moves concomitantly with the cover. In accordance with embodiments, the second sheet is a plastic sheet and comprises a plastic material. The plastic material is, in particular, a thermostable Plexiglas (polymethyl methacrylate, PMMA, or poly(methyl methacrylimide), PMMI). The plastic material has, in particular, a Vicat softening temperature of greater than 100° C. (parameter B/50) according to ISO306. By way of example, the plastic material has a Vicat softening temperature of greater than 110° C., greater than 115° C. or greater than 120° C.

The value of the refractive index of the plastic material is, for example, in a range of n=1.4 to n=1.7. In particular, the value of the refractive index of the plastic material is in a range of n=1.48 to n=1.60. By way of example, the value of the refractive index of the plastic material is n=1.51 or n=1.54.

In accordance with embodiments, the second sheet comprises a plurality of nanoparticles. The nanoparticles are embedded in the plastic material in order to scatter light. The nanoparticles are distributed as uniformly as possible over the volume of the second sheet. Light guided in the second sheet is scattered at the nanoparticles, such that it couples out from the second sheet and thus from the cover. Consequently, light waves that are coupled into the second sheet from the light source during operation first of all are distributed uniformly over the second sheet as a result of the total internal reflection and are scattered by the nanoparticles. The light waves are coupled out from the second main surface of the second sheet largely uniformly over the area of the second sheet. It is thus possible to provide a planar illumination for the interior of the motor vehicle roof by means of the cover. Alternatively or additionally, the second sheet in accordance with embodiments has a print at which the light is scattered, such that it couples out from the second sheet and thus from the cover. Alternatively or additionally, the second sheet in accordance with embodiments has a laser structuring at which the light is scattered, such that it couples out from the second sheet and thus from the cover. Alternatively or additionally, the second sheet in accordance with embodiments has an embossing at which the light is scattered, such that it couples out from the second sheet and thus from the cover. Alternatively or additionally, the second sheet in accordance with embodiments has a structuring which is introduced by a mechanical processing and at which the light is scattered, such that it couples out from the second sheet and thus from the cover.

The size of the nanoparticles is typically in a range of 1 to 100 nm. By way of example, the nanoparticles are formed from a metal, a semiconductor, a polymer or some other material from which correspondingly small particles can be produced. By way of example, carbon-containing nanoparticles are used, or carbon black particles. The nanoparticles are indiscernible to the human eye without aids. Consequently, the cover, and in particular the plastic sheet, has a uniform visual appearance. In particular, the plastic sheet has a uniform transparency.

In accordance with embodiments, the layer stack has a transparency of greater than 1%, in particular greater than 5%, for the human eye. The transparency is, in particular, less than 90%. The lower the transparency, the lower the energy input into the interior of the motor vehicle. The greater the transparency, the freer the view from the interior of the motor vehicle towards the outside. In particular, the layer stack has a predefined transparency for the wavelength of light visible to the human eye of approximately 400 nm to approximately 800 nm. The transparency of the cover is dependent on a tint of the first sheet, which results in a reduction of the transparency. The energy input into the interior of the motor vehicle is reduced by the tint of the first sheet. Moreover, the transparency of the cover is dependent on the transparency of the second sheet. The second sheet has the highest possible transparency. Consequently, the heating of the interior of the motor vehicle by the insolation of sunlight is reduced and, moreover, reliable light guiding and planar illumination are possible by means of the cover. In addition, the transparency of the cover is dependent on the transparency of the adhesive.

For the total internal reflection at the transition between the plastic sheet and the adhesive at the main surface, the adhesive is chosen such that the value of the refractive index of the adhesive deviates from the value of the refractive index of the plastic material of the plastic sheet. In particular, the value of the refractive index of the adhesive is less than the value of the refractive index of the plastic material, for example, less by at least 0.01. By way of example, the value of the refractive index of the adhesive is in a range of n=1.0 to n=1.6. In particular, the value of the refractive index of the adhesive is in a range of n=1.0 to n=1.54. By way of example, the adhesive has a refractive index of n=1.41 or n=1.48.

Further advantages, features and developments will become apparent from the following examples explained in conjunction with the figures. Elements that are identical, of identical type or act identically may be provided with the same reference signs in this case. The elements shown and their size relationships with respect to one another are not true to scale. Rather, individual elements may be illustrated with exaggerated thickness or size for example in order to enable better illustration or in order to afford a better understanding.

In the figures:

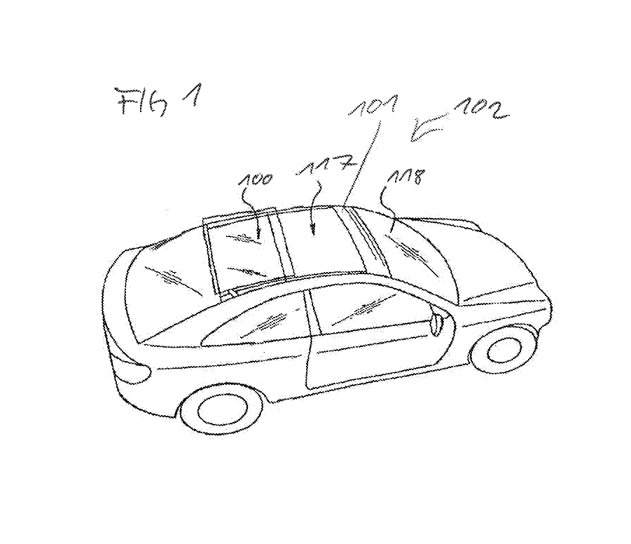

FIG. 1 shows a schematic illustration of a motor vehicle in accordance with embodiments, and

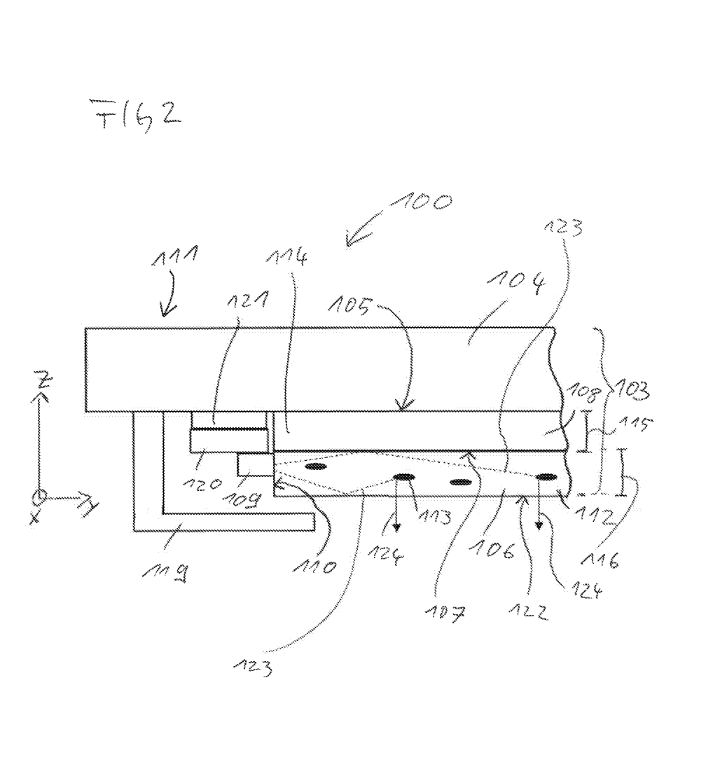

FIG. 2 shows a schematic illustration of an excerpt from a cover for a motor vehicle in accordance with embodiments.

FIG. 1 shows a motor vehicle 102. The motor vehicle comprises a motor vehicle roof 101. The motor vehicle roof comprises a roof opening 117. The roof opening can be closed by a cover 100. In accordance with embodiments, the cover 100 is arranged moveably relative to the rest of the vehicle roof 101. As a result, it is possible optionally to close or at least partly free the roof opening 117 by means of the cover 100. By way of example, the cover 100 is part of a panoramic roof, a spoiler roof, a sliding roof, for example an externally guided sliding roof, and/or a tilt/slide roof and/or a fixed glass element. The motor vehicle 102 is a car, for example.

FIG. 2 shows an edge excerpt from the cover 100 in cross-section in accordance with embodiments.

The cover 100 comprises a layer stack 103, which is stacked in the Z-direction. The layer stack comprises a sheet 106, for example a plastic sheet. In accordance with further exemplary embodiments, the sheet 106 is composed of a different material, for example glass. The sheet 106 is explained below on the basis of the example of a plastic sheet, in which case advantages and functions are also applicable to the further exemplary embodiments (not explicitly illustrated), in which the sheet 106 is composed from a different material.

An adhesive 108 is arranged on a main surface 107 of the plastic sheet 106. A sheet 104 is arranged on a side of the adhesive 108 that faces away from the plastic sheet 106. In accordance with further exemplary embodiments, the sheet 104 is composed of a different material, for example plastic. The sheet 104 is explained below on the basis of the example of a glass sheet, in which case advantages and functions are also applicable to the further exemplary embodiments (not explicitly illustrated), in which the sheet 104 is composed of a different material.

The glass sheet is in contact with the adhesive 108 by a main surface 105. The adhesive connects the glass sheet 104 to the plastic sheet 106.

The main propagation direction of the cover 100, of the glass sheet 104 and of the plastic sheet 106 extends in each case transversely with respect to the Z-direction. The cover 100 has a larger extent in each case in the Y- and X-directions than in the Z-direction.

The glass sheet 104 has a region 111 projecting in the direction of the main surface 105. The projecting region 111 projects beyond the adhesive 108 and the plastic sheet 106. No adhesive 108 and no plastic sheet 106 are provided at the projecting region 111. An illuminant is fixed to the projecting region 111 by means of a further adhesive 121. The further adhesive is a double-sided adhesive tape, for example.

The illuminant comprises, for example, a circuit board, a flexible printed circuit board, a flexible cable or a rigid printed circuit board 120 and a light source 109. The light source 109 is a light-emitting diode (LED), in particular. In accordance with embodiments, the light source 109 comprises a plurality of LEDs. The light source 109 generates white light or coloured light, for example. In accordance with embodiments, the colour locus of the light source 109 is variable during operation. In accordance with further embodiments, the light source 109 alternatively or additionally has a light guiding element.

In accordance with embodiments, a screen 119 is arranged at the projecting region, in order to cover the circuit board 120 and the light source 109. Consequently, the light source 109 is protected and a uniform visual appearance of the cover 100 is possible. In accordance with further embodiments, the screen 119 is dispensed with.

The glass sheet 104 is a tinted glass sheet, in particular. The glass sheet 104 is tinted such that it protects the interior of the motor vehicle 102 against excessive heating as a result of an energy input, for example against an energy input as a result of solar radiation. The glass sheet 104 is tinted such that is has a sufficiently high transparency for the human eye, such that occupants of the motor vehicle 102 can look through the cover 100 and in particular through the glass sheet 104 towards the outside. The glass sheet 104 is, in particular, single-pane safety glass (SPSG), and, for example, grey glass. The glass sheet 104 has a thickness of more than 2 mm, for example, in the Z-direction.

The adhesive 108 is a hot melt adhesive film 114, for example. By way of example, a TPU or tectosil is used as adhesive 108. An adhesive 108 is used whose value of the refractive index deviates from the value of the refractive index of the material of the plastic sheet 106, for example by at least 0.01. In particular, an adhesive 108 is used whose refractive index n is in a range of 1.0 to 1.54. The adhesive 108 has a thickness 115 in the Z-direction in a range of 0.01 mm to 3 mm.

The plastic sheet 108 comprises a plastic material 112. The plastic material is a transparent material having good thermostability properties. By way of example, the plastic material 112 is a PMMA, a PMMI, a polyamide, a PET or a PC. The plastic material 112, in the case of a parameter of B/50, has a Vicat softening temperature of, for example, 119° C.±1% according to ISO306. The dimensional stability temperature of the plastic material 112 according to ISO75 is, for example, greater than 100° C., in particular 109° C.±1%, in the case of a parameter of 0.45 MPa.

The plastic sheet 106 has a thickness 116 in the Z-direction in a range of 0.5 to 4 mm.

The plastic material 112 has a value of the refractive index which deviates from the value of the refractive index of the adhesive 102, for example by at least 0.01. In particular, the plastic sheet 106 has a value of the refractive index which deviates from the value of the refractive index of the adhesive 102, for example by at least 0.01. By way of example, the refractive index of the plastic material 112 has a value in a range of n=1.48 to n=1.60.

By way of example, a plastic material 112 having a refractive index of n=1.51 is used. By way of example, in addition an adhesive 108 having a refractive index of n=1.48 or n=1.41 is used. In accordance with further embodiments, a plastic material 112 having a refractive index of n=1.54 is used in combination with an adhesive having a refractive index of n=1.48.

The plastic material 112 has a thermostability, such that the plastic sheet 106 changes only within predefined limit values during normal operation of the motor vehicle 102 with the corresponding temperatures.

A plurality of nanoparticles 113 are embedded into the plastic material 112 of the plastic sheet 106. A nanoparticle 113 has a size of from a few nanometres to a few 100 nm. The nanoparticles are in each case designed to scatter light. The nanoparticles are composed of a material which can be shaped to form correspondingly small particles. By way of example, the nanoparticles are formed from a carbon black, a metal or some other correspondingly formable material. The nanoparticles 113 are distributed as uniformly as possible in the plastic material 112. The number of nanoparticles 113 in the plastic material 112 is predefined such that the transparency of the plastic material 112 is not impaired or is impaired only to an insignificant extent. In addition, the number of nanoparticles 113 in the plastic material 112 is predefined such that good and uniform coupling-out of light from the plastic sheet 106 is possible during operation.

The light source 109 is arranged relative to the plastic sheet 106 such that light 123 from the light source 109 couples into the plastic sheet 106 via a side 110. In particular, the light 123 from the light source 109 is coupled into the plastic sheet 106 as centrally as possible. The side 110 extends in the Z-direction and transversely with respect to the main direction of extent of the plastic sheet 106. As a result of the jump in refractive index between the plastic material 112 and the adhesive 108 at the main surface 107, the coupled-in light 123 is reflected at the main surface 107. As little light as possible emerges at the main surface 107. The plastic sheet 106 has a second main surface 122, which extends in the Y- and X-directions and is situated opposite the main surface 107.

At the second main surface 122, a jump in refractive index is provided by the transition from the plastic material 112 to air. As a result, the best possible reflection of the light 123 occurs at the second main surface 122 as well. The light is coupled in by the light source 109 at the shallowest possible angle with respect to the main surfaces 107 and 122, in order to increase the reflection. If the light 123 impinges on one or more nanoparticles 113, the light 123 is scattered at the latter. The scattered light 124, which impinges on the main surface 122 at a steep angle, is reflected as little as possible. Consequently, the scattered light 124 emerges from the cover 100 at the main surface 122. The main surface 122 faces the interior of the motor vehicle 102. Consequently, planar illumination of the vehicle interior is made possible by the light source 109 and the plastic sheet 106.

As an alternative or in addition to the nanoparticles 113, the plastic material 112 in accordance with further exemplary embodiments (not explicitly illustrated) has a print in order to scatter the light 123. Alternatively or additionally, the plastic material 112 in accordance with further exemplary embodiments (not explicitly illustrated), is structured by means of a laser in order to scatter the light 123. Alternatively or additionally, the plastic material 112 in accordance with further exemplary embodiments (not explicitly illustrated) has an embossing in order to scatter the light 123. Alternatively or additionally, the plastic material 112 in accordance with further exemplary embodiments (not explicitly illustrated) is mechanically structured in order to scatter the light 123.

The light source 109 extends at the cover 100 for example in a front region facing a windscreen 118. In accordance with further embodiments, the light source 109 alternatively or additionally extends into a rear region of the cover 100, which faces away from the windscreen 118. In accordance with further embodiments, the light source 109 is alternatively or additionally arranged in a lateral region of the cover 100. The light source 109 is arranged only at one side of the cover 100 in accordance with embodiments or at both sides in accordance with embodiments.

The use of the thermostable plastic material 112 with the nanoparticles 113 and an increased refractive index improves the optical, thermal and mechanical properties of the layer stack 103. The difference in refractive index between the plastic material and the hot melt adhesive film is at least 0.01. By way of example, the difference in refractive index between the plastic material 112 and the adhesive 108 is greater than 0.05, in particular greater than or equal to 0.1. The jump in refractive index is chosen with a magnitude such that the best possible reflection takes place at the transition between the plastic material 112 and the adhesive 108.

As a result of the use of the tinted glass sheet 104 in the plastic-glass composite of the layer stack 103, the energy input in the motor vehicle interior is reduced and an illumination function of the cover 100 is realised.

The optical properties of the adhesive 108 and of the plastic material 112 are predefined such that total internal reflection of the light rays occurs in the plastic light guiding material 112. Homogeneous planar coupling-out of light over the entire or virtually the entire surface 122 of the plastic sheet 106 is thus made possible.

1. A cover for a motor vehicle roof, comprising a layer stack having:
a first sheet of planar extent having a main surface,
a second sheet of planar extent having a main surface,
an adhesive arranged between the main surfaces and serving for fixing the second sheet to the first sheet, wherein
the refractive index of the second sheet has a first value and the refractive index of the adhesive has a second value such that a difference between the first value and the second value is greater than zero, in particular greater than or equal to 0.01.

2. The cover according to claim 1, further comprising:
a light source, which is arranged laterally with respect to the second sheet in order to couple light into a side of the second sheet which is transverse with respect to the main surface.

3. The cover according to claim 2, wherein the first sheet has a region projecting beyond the second sheet, and wherein the light source is arranged at the projecting region.

4. The cover according to claim 1, wherein the second sheet comprises a plastic material and a plurality of nanoparticles embedded in the plastic material, and/or a print and/or laser structuring and/or an embossing or a mechanical structuring in order to scatter light.

5. The cover according to claim 4, wherein the plastic material has a Vicat softening temperature of greater than 100° C.

6. The cover according to claim 4, wherein the value of the refractive index of the plastic material is in a range of 1.40 to 1.70.

7. The cover according to claim 1, wherein the layer stack has a transparency of greater than 1% for the human eye.

8. The cover according to claim 1, wherein the adhesive comprises a hot melt adhesive film having a thickness transversely with respect to the main surface in a range of 0.01 mm to 3 mm.

9. The cover according to claim 1, wherein the second sheet has a thickness transversely with respect to the main surface in a range of 0.5 mm to 4 mm.

10. The cover according to claim 1, wherein the value of the refractive index of the adhesive is in a range of 1.00 to 1.60.

11. The cover according to claim 1, wherein the first sheet is a glass sheet or a plastic sheet.
